(19) United States
(12) Patent Application Publication
(10) Pub. No.: US 2017/0030221 A1
(43) Pub. Date: Feb. 2, 2017

(54) BEARING SUPPORT HOUSING FOR A GAS TURBINE ENGINE

(71) Applicant: GENERAL ELECTRIC COMPANY, Schenectady, NY (US)

(72) Inventors: Mark Leonard HOPPER, West Chester, OH (US); Andrew Michael WATSON, Cincinnati, OH (US); Pablo Gabriel PIAZZA, Cincinnati, OH (US)

(21) Appl. No.: 15/304,175

(22) PCT Filed: Apr. 10, 2015
(86) PCT No.: PCT/US2015/025225

§ 371 Date: Oct. 14, 2016

Related U.S. Application Data
(60) Provisional application No. 61/980,104, filed on Apr. 16, 2014.

(51) Int. Cl. F01D 25/16; F01D 25/28

(52) U.S. Cl. CPC F01D 25/164; F01D 25/28; F05D 2220/32; F05D 2240/54; F05D 2240/60; F05D 2240/55

(57) ABSTRACT

A bearing support housing for a gas turbine engine includes, in radial sequence from a center outwards: an inner ring defining a central bore; a middle ring including an array of inner slots, an outer web including an array of outer slots, wherein the inner and outer slots are positioned, sized, and shaped so as to divide the middle ring and the outer web into an array of tangentially-extending beams and radially-extending inner and outer struts; and an outer ring.

### BACKGROUND OF THE INVENTION

The present invention relates to bearings used in gas turbine engines, and more particularly to a bearing support for mounting a rolling-element bearing within a gas turbine engine.

A gas turbine engine includes one or more shafts which are mounted for rotation in several bearings, usually of the rolling-element type. The bearings are enclosed in enclosures called “sumps” which are pressurized and provided with an oil flow for lubrication and cooling. The bearings in a gas turbine engine are usually a combination of roller and ball bearings.

Gas turbine engine mainshaft bearings require a mount structure with a specific radial stiffness to properly tune engine dynamics over their operating range. In some cases it is a challenge to meet the target stiffness without creating a stress problem in the structure.

One known type of bearing mounting structure is a conical housing which is essentially rigid in the radial direction (except for the inherent flexibility of the constituent material). Another known type of mounting structure incorporates a radial array of axially-extending spring “fingers” which suspend a bearing and permit controlled deflection in the radial direction.

The internal configuration of certain gas turbine engines could benefit from a bearing mount radial stiffness lower than would be provided by a traditional cone mount (i.e. “softer”), yet stiffer than is typically achieved with spring fingers.

### BRIEF DESCRIPTION OF THE INVENTION

This need is addressed by embodiments of the present invention, which provides a bearing support housing incorporating a plurality of integral tangential and radial beams as well as built-in deflection limiters.

According to an embodiment of the invention, a bearing support housing for a gas turbine engine, includes, in radial sequence from a center outwards: an inner ring defining a central bore; a middle ring including an array of inner slots, an outer web including an array of outer slots, wherein the inner and outer slots are positioned, sized, and shaped so as to divide the middle ring and the outer web into an array of tangentially-extending beams and radially-extending inner and outer struts; and an outer ring.

According to an embodiment of the invention, the inner ring includes an axially-extending inner lip.

According to an embodiment of the invention, the inner ring is pierced with an array of inner holes.

According to an embodiment of the invention, an annular inner web is disposed between the inner ring and the middle ring.

According to an embodiment of the invention, the inner web is pierced with weight-reduction openings.

According to an embodiment of the invention, the middle ring is pierced with an array of middle holes.

According to an embodiment of the invention, the outer ring is pierced with an array of outer holes.

According to an embodiment of the invention, a bearing apparatus of a gas turbine engine includes: a stationary frame; an annular bearing support housing mounted in the frame; a bearing mounted in a central bore of the bearing support housing; and a shaft mounted in the bearing, wherein the bearing support housing includes a plurality of flexible tangential beams that permit limited radial movement of the bearing relative to the frame.

According to an embodiment of the invention, a portion of the bearing support housing is captured in a bolted joint configured to limit radial deflection of the bearing to a predetermined magnitude.

According to an embodiment of the invention, the bearing support housing includes an inner lip that interacts with a seal flange of the bolted joint to limit radial deflection of the bearing.

According to an embodiment of the invention, the bolted joint is configured to maintain the beams in a single plane even if one or more of the tangential beams is cracked.

According to an embodiment of the invention, the stationary frame is a turbine frame.

According to an embodiment of the invention, the bearing is a rolling element bearing.

According to an embodiment of the invention, the bolted joint captures the middle ring between a stationary, annular air seal and a stationary, annular sump cover.

### BRIEF DESCRIPTION OF THE DRAWINGS

Embodiments of the invention may be best understood by reference to the following description taken in conjunction with the accompanying drawing figures, in which:

FIG. 1 is a schematic half-sectional view of representative gas turbine engine, incorporating a shroud assembly constructed in accordance with an aspect of the present invention;

FIG. 2 is a schematic sectional view of a portion of a sump and bearing support housing constructed in accordance with the present invention;

FIG. 3 is a perspective view of the bearing support housing shown in FIG. 2;

FIG. 4 is a rear elevation view of a portion of the bearing support housing shown in FIG. 3; and

FIG. 5 is an enlarged view of a portion of FIG. 2.

### DETAILED DESCRIPTION OF THE INVENTION

In general, the present invention provides a bearing support housing incorporating relatively thin, flexible members to produce a desired degree of radial flexibility while avoiding stress and life issues by incorporating deflection limiters to mitigate stress during high load events.

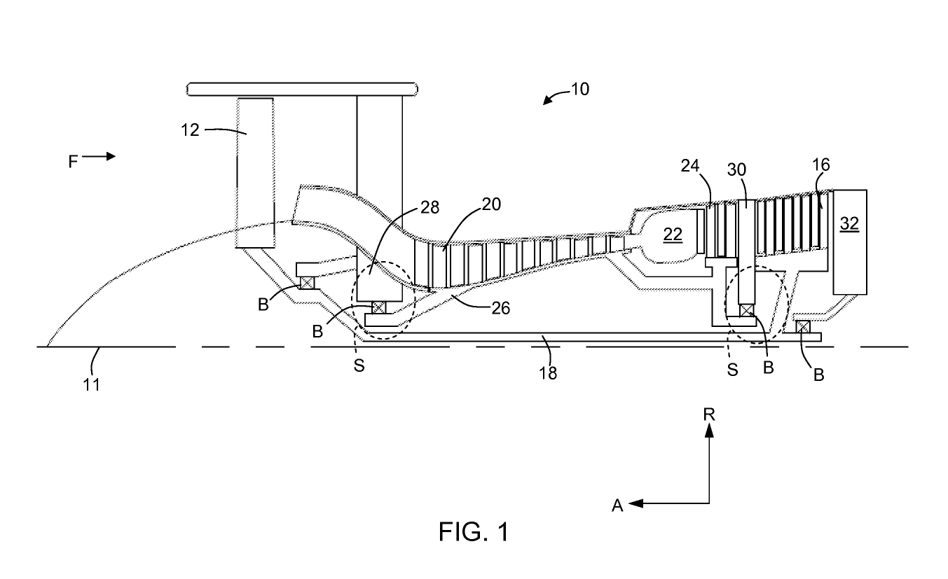

Now, referring to the drawings wherein identical reference numerals denote the same elements throughout the various views, FIG. 1 depicts in schematic half-section a gas turbine engine 10. The engine 10 has a longitudinal or centerline axis 11 and includes a fan 12 and a low pressure turbine (“LPT”) 16, collectively referred to as a “low pressure system”. The LPT 16 drives the fan 12 through an inner shaft 18, also referred to as an “LP shaft”. The engine 10 also includes a high pressure compressor (“HPC”) 20, a combustor 22, and a high pressure turbine (“HPT”) 24, collectively referred to as a “gas generator” or “core”. The HPT 24 drives the HPC 20 through an outer shaft 26, also referred to as an “HP shaft”. Together, the high and low pressure systems are operable in a known manner to generate a primary or core flow as well as a fan flow or bypass flow. While the illustrated engine 10 is a high-bypass turbofan engine, the principles described herein are equally applicable to turboprop, turbojet, and turboshaft engines, as well as turbine engines used for other vehicles or in stationary applications.

It is noted that, as used herein, the term “axial” or “longitudinal” refers to a direction parallel to the longitudinal axis 11, while “radial” refers to a direction perpendicular to the axial direction, and “tangential” or “circumferential” refers to a direction mutually perpendicular to the axial and tangential directions. (See arrows “A”, “R”, and “T” in FIG. 1). As used herein, the terms “forward” or “front” refer to a location relatively upstream relative to the air flow passing through the engine 10, and the terms “aft” or “rear” refer to a location relatively downstream in an air flow passing through or around the engine 10. The direction of this flow is shown by the arrow “F” in FIG. 1. These directional terms are used merely for convenience in description and do not require a particular orientation of the structures described thereby.

The engine 10 includes a stationary structure comprising various casings, shrouds, and frames assembled into a functional, non-rotating assembly generically referred to herein as the engine's “stationary structure.” Some of the stationary components that make up this stationary structure are a fan frame 28, a turbine center frame 30, and a turbine rear frame 32.

The inner and outer shafts 18 and 26 are mounted for rotation relative to the stationary structure using several rolling-element bearings, generally denoted “B” in FIG. 1. The bearings B in a gas turbine engine are usually a combination of roller and ball bearings. The bearings B are located in one or more enclosed portions of the engine 10 referred to as “sumps”, generally denoted “S” in FIG. 1. The sumps S are pressurized and operatively coupled to means for providing an oil flow for lubrication and cooling, and scavenging the spent oil flow, in a known manner.

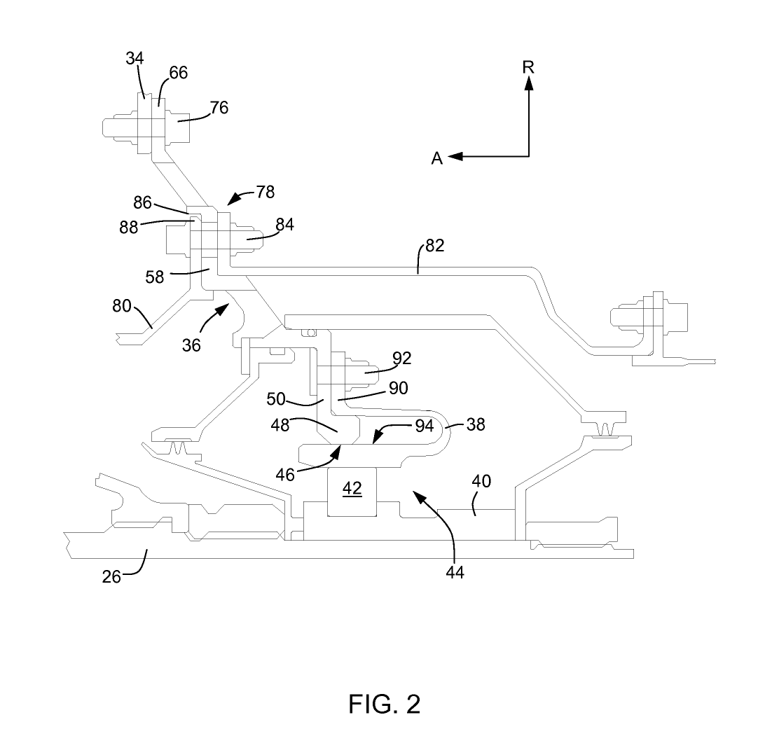

FIG. 2 illustrates a portion of a sump S of the engine 10. Within the sump, the outer shaft 26 is surrounded by the turbine center frame 30. An annular, generally conical bearing support housing 36 is mounted an annular frame flange 34 of the turbine center frame 30, and extends radially inward to an annular bearing outer race 38. The outer race 38 surrounds a bearing inner race 40 which is mounted to the outer shaft 26. An array of rolling elements 42 (generally cylindrical rollers in this example) are disposed between the inner and outer races 40 and 38. Collectively, the inner race 40, the rolling elements 42, and the outer race 38 constitute a bearing 44.

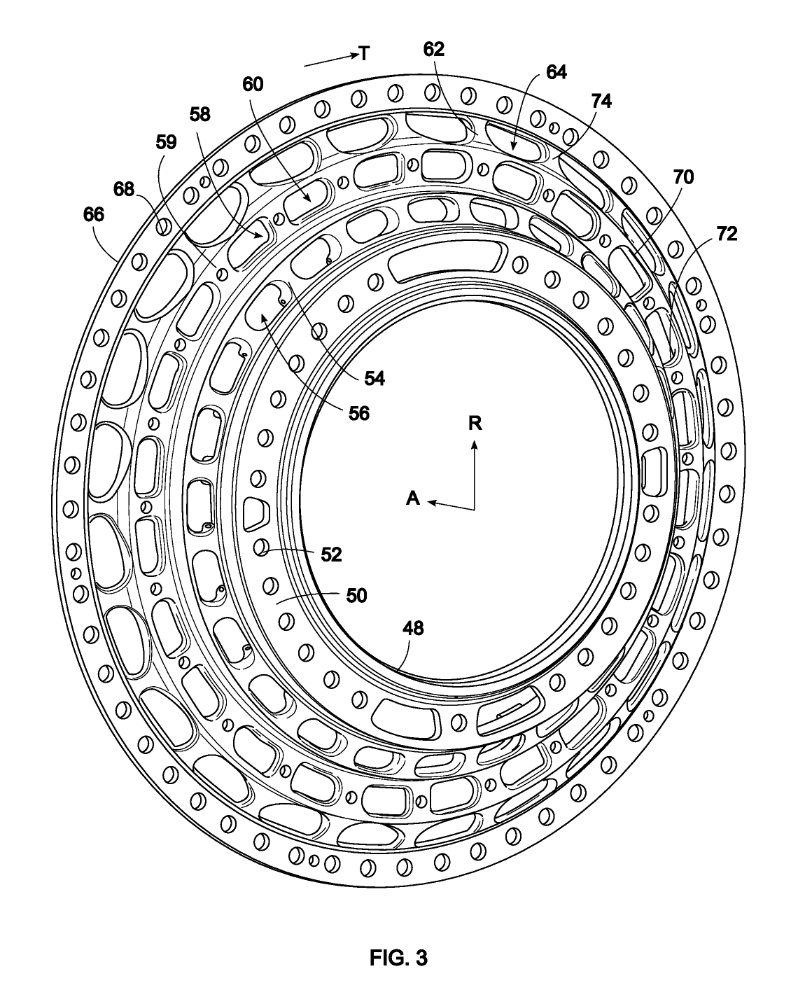

As seen in FIGS. 2 and 3, the bearing support housing 36 includes a central bore 46 defined by an annular, axially-extending inner lip 48. Radially outboard of the inner lip 48 is an annular, radially-extending inner ring 50, pierced with an array of inner holes 52. Radially outboard of the inner ring 50 is an inner web 54, which may optionally be pierced by an array of weight-reduction openings 56. Radially outboard of the inner web 54 is an annular, radially-extending middle ring 58, pierced with an array of middle holes 59 which alternate with an array of inner slots 60. Radially outboard of the middle ring 58 is an outer web 62, pierced with an array of outer slots 64. Finally there is an annular, radially-extending outer ring 66, pierced with an array of outer holes 68.

The inner and outer slots 60 and 64 are positioned, sized, and shaped so as to divide the middle ring 58 and the outer web 62 into a plurality of relatively slender, flexible portions, in particular an array of tangentially-extending beams 70 and radially-extending inner and outer struts 72 and 74, respectively. Each of the inner struts 72 has one of the middle holes 59 passing therethrough.

The outer ring 66 is clamped to the frame flange 34 with a plurality of mechanical fasteners 76 passing through the outer holes 68, such as the illustrated bolts (and accompanying nuts).

The middle ring 58 is clamped in a middle bolted joint 78 between a stationary, annular forward air seal 80 and a stationary, annular sump cover 82, using a plurality of mechanical fasteners 84 such as the illustrated bolts and accompanying nuts. The fasteners pass through the middle holes 59 and corresponding holes in the forward air seal 80 and the sump cover 82. A radially outer portion of the middle ring 58 extends axially forward to define a lip 86 which axially overlaps a seal flange 88 of the forward air seal 80.

The inner ring 50 is clamped to a race flange 90 of the outer race 38 with a plurality of mechanical fasteners 92 passing through the inner holes 52, such as the illustrated bolts (and accompanying nuts). A generally cylindrical inner surface 94 of the hairpin-shaped outer race 38 extends axially in close radial proximity to the central bore 46, cooperatively defining a thin annular squeeze film space therebetween. In accordance with known principles, a damper fluid such pressurized oil may be introduced into the squeeze film space, to provide a damping action on the bearing 44 and outer shaft 26.

In operation, the outer shaft 26 is subject to movement in the radial direction R relative to the turbine center frame 30, causing radial deflections and imposing mechanical loads in the components interconnecting the outer shaft 36 and the turbine center frame 30. The presence of the beams 70 of the bearing support housing 36 increases the circumferential distance of the mechanical load path from the inner bore 46 to the outer flange 66. The bearing support housing 36 therefore has a lower radial stiffness than a prior art straight conical housing. This permits flexibility and radial deflection of the bearing 44 as required.

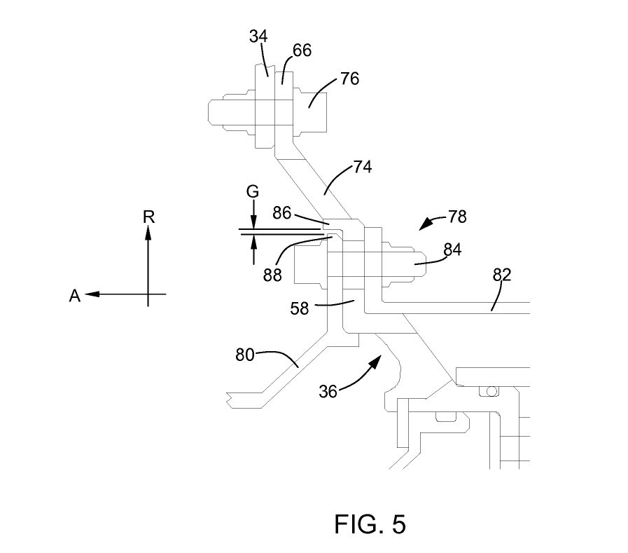

To limit the maximum bending stress in the beams 70, the middle bolted joint 78 is configured to limit radial deflection of the bearing 44 to a predetermined magnitude. More specifically, when the bearing 44 is in an undeflected position, the axial lip 86 and the adjacent seal flange 88 define a radial gap “G”, as best seen in FIG. 5. In operation, as the bearing 44 and beams 70 deflect outboard in the radial direction R, the bolt 84 and the forward air seal 58 also move outboard, closing the gap “G”. When the gap G is fully closed the seal flange 88 abuts the axial lip 86, preventing both further radial movement of the bearing 44 and further deflection of the beams 70.

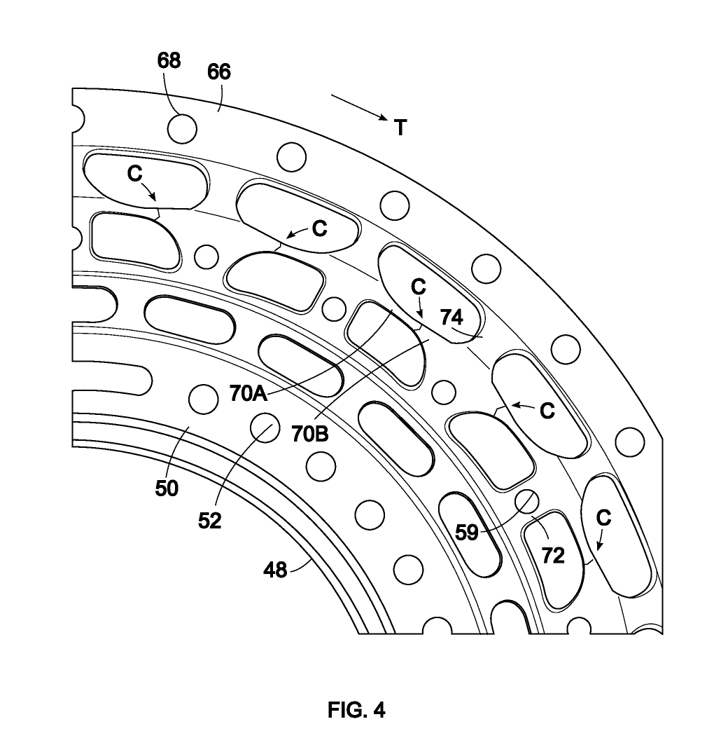

Under some circumstances it is possible that one or more of the tangential beams 70 could crack and separate. FIG. 4 illustrates the beams 70 with exemplary cracks “C” passing through them. The bearing support housing 36 and the middle bolted joint 78 present a design that is tolerant to such cracks. More specifically, they are configured to provide retention and limit deflection of the inboard portion of the bearing support housing 36 in axial, radial and tangential directions should cracking occur. As seen in FIG. 5, the forward air seal 80 and the sump cover 82 overlap the beams 70 in the radial direction R. This provides positive stops against forward or aft motion of the broken parts.

As seen in FIGS. 4 and 5, the bolted joint 78 maintains all of the sections of the middle flange 58 in a single plane. Therefore, even if one of the beams 70 should be cracked, a mechanical load path for radial loads will be present from the inner strut 72, across the beam 70, and into the adjacent outer strut 74.

Finally, in the tangential direction, a load path will be present from one half of a cracked beam 70 (labeled 70A in FIG. 4) to the other half of the beam 70 (labeled 70B), and then into the adjacent outer strut 74, prevent tangential motion of the broken parts.

The bearing support apparatus described herein has several advantages compared to the prior art. It provides a required bearing mount stiffness while meeting stress and life requirements and provides a lower weight solution for mounting a bearing. It also incorporates deflection limiters , limiting the maximum stress in the structure during high load events. The configuration is fault-tolerant and the structure is sustained in the event of a fracture.

The foregoing has described a bearing support housing for a gas turbine engine. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying potential points of novelty, abstract and drawings), or to any novel one, or any novel combination, of the steps of any method or process so disclosed.

What is claimed is:

1. A bearing support housing for a gas turbine engine, comprising, in radial sequence from a center outwards:
an inner ring defining a central bore;
a middle ring including an array of inner slots,
an outer web including an array of outer slots, wherein the inner and outer slots are positioned, sized, and shaped so as to divide the middle ring and the outer web into an array of tangentially-extending beams and radially-extending inner and outer struts; and
an outer ring.

2. The bearing support housing of claim 1 wherein the inner ring includes an axially-extending inner lip.

3. The bearing support housing of claim 1 wherein the inner ring comprises an array of inner holes.

4. The bearing support housing of claim 1 wherein an annular inner web is disposed between the inner ring and the middle ring.

5. The bearing support housing of claim 4 wherein the inner web comprises weight-reduction openings.

6. The bearing support housing of claim 1 wherein the middle ring comprises an array of middle holes.

7. The bearing support housing of claim 1 wherein the outer ring comprises an array of outer holes.

8. A bearing apparatus of a gas turbine engine, comprising:
a stationary frame;
an annular bearing support housing mounted in the frame;
a bearing mounted in a central bore of the bearing support housing; and
a shaft mounted in the bearing, wherein the bearing support housing includes a plurality of flexible tangential beams that permit limited radial movement of the bearing relative to the frame.

9. The apparatus of claim 8 where a portion of the bearing support housing is captured in a bolted joint configured to limit radial deflection of the bearing to a predetermined magnitude.

10. The apparatus of claim 9 where the bearing support housing includes an inner lip that interacts with a seal flange of the bolted joint to limit radial deflection of the bearing.

11. The apparatus of claim 9 wherein the bolted joint is configured to maintain the beams in a single plane even if one or more of the tangential beams is cracked.

12. The apparatus of claim 8 wherein the inner ring comprises an array of inner holes.

13. The apparatus of claim 7 wherein an annular inner web is disposed between the inner ring and the middle ring.

14. The apparatus of claim 13 wherein the inner web comprises weight-reduction openings.

15. The apparatus of claim 8 wherein the middle ring comprises an array of middle holes.

16. The apparatus of claim 8 wherein the outer ring comprises an array of outer holes.

17. The apparatus of claim 8 wherein the stationary frame is a turbine frame.

18. The apparatus of claim 8 wherein the bearing is a rolling element bearing.

19. The apparatus of claim 9 wherein the bolted joint captures the middle ring between a stationary, annular air seal and a stationary, annular sump cover.
